(19) United States
(12) Patent Application Publication
(10) Pub. No.: US 2023/0029606 A1
(43) Pub. Date: Feb. 2, 2023

(54) LIFTING APPARATUS

(71) Applicant: Brian Paul Froese, Salmon Arm (CA)

(72) Inventor: Brian Paul Froese, Salmon Arm (CA)

(21) Appl. No.: 17/443,870

(22) Filed: Jul. 28, 2021

(51) Int. Cl. B66F 11/04; B25H 5/00

(52) U.S. Cl. CPC B66F 11/04; B25H 5/00

(57) ABSTRACT

A personal portable lift platform that is configured to move a user to an elevated position and is further operable to be moved by the user in the elevated position. The lift platform of the present invention includes a frame having a lower portion wherein the lower portion includes a first section and second section on opposing sides of the frame. A vertical support member extends upward from the lower portion. The vertical support member has a base platform movably coupled thereto wherein the base platform traverses in an upwards-downwards direction. The frame is coupled to wheel of which two have a drive motor coupled thereto. A control station is superposed the base platform having control interface elements to provide operation of the lift platform. A motor and cable assembly is secured to the vertical support platform and configured to move the base platform.

### FIELD OF THE INVENTION

The present invention relates generally to working platforms, more specifically but not by way of limitation, a transportable work platform that is configured to receive a user and subsequently provide elevation so as to lift the user to an area above them so as to assist in execution of a desired task.

### BACKGROUND

As is known in the art, various types of tasks can require specific tools to execute the tasks. There are many types of commercial and maintenance type tasks that require a user to reach an elevated location. By way of example but not limitation, electrical work in ceilings, painting, plumbing and changing light bulbs can all require the use of a ladder in order to assist the user in completing the task. Ladders come in various sizes and types with the two most common being an extension ladder and a step ladder. The latter type of ladder is typically provided in lengths from three to ten feet and is the most common type of ladder utilized to perform tasks such as but not limited to the tasks mentioned herein above. Ladders are inherently risky and tens of thousands of people a year are taken to the hospital as a result of falling from a ladder.

One issue with ladders is the relatively small rungs on which the user has to stand while executing the task. A typical rung is no more than a few inches wide and as such presents a surface on which a user's foot will overhang in both directions. Additionally, individuals who are routinely on ladders to execute tasks such as but not limited to tradesmen, will climb up and down ladders while carrying tools sometimes fifty or more times in a single day. Each traversing up and down the ladder presents a safety risk for the individual. Additionally, another drawback is the lack of space a conventional step ladder provides to maintain tools within reach of the user.

It is intended within the scope of the present invention to provide a transportable lift platform wherein the lift platform of the present invention is configured to provide a surface for a user that can be elevated and further be moved while the user is in an elevated position.

### SUMMARY OF THE INVENTION

It is the object of the present invention to provide a lift platform configured to receive a single user thereon and provide lifting of the user to a desired height wherein the present invention includes a base platform.

Another object of the present invention is to provide a lifting platform configured to lift a user and further provide an area large enough for additional items such as but not limited to tools wherein the base platform is movably coupled to a vertical support member.

A further object of the present invention is to provide a lift platform configured to receive a single user thereon and provide lifting of the user to a desired height that further includes a lower support structure wherein the lower support structure includes structural members secured to the lower portion of the vertical support member and extends outward therefrom.

Still another object of the present invention is to provide a lifting platform configured to lift a user and further provide an area large enough for additional items such as but not limited to tools wherein the lower support structure includes wheels secured thereto.

An additional object of the present invention is to provide a lift platform configured to receive a single user thereon and provide lifting of the user to a desired height wherein the wheels secured to the lower support structure are operably coupled to at least one electric motor.

Yet a further object of the present invention is to provide a lifting platform configured to lift a user and further provide an area large enough for additional items such as but not limited to tools wherein the tower support member includes disposed therein a winch and cable assembly that are operably coupled to the base platform.

Another object of the present invention is to a provide a lift platform configured to receive a single user thereon and provide lifting of the user to a desired height wherein the present invention includes a control station that is operably coupled to the motor operating the winch and cable assembly and the at least one electric motor controlling the wheels.

An alternate object of the present invention is to provide a lifting platform configured to lift a user and further provide an area large enough for additional items such as but not limited to tools wherein a preferred embodiment of the base platform is two feet by two feet in size.

Another object of the present invention is to a provide a lift platform configured to receive a single user thereon and provide lifting of the user to a desired height wherein the frame of the present invention is manufactured from lightweight metal so as to facilitate an ability for the present invention to be portable.

An alternate object of the present invention is to provide a lifting platform configured to lift a user and further provide an area large enough for additional items such as but not limited to tools wherein a preferred embodiment of the present invention lifts the base platform to be six feet in height.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the body of the present invention; and

FIG. 2 is a side view of an embodiment of the present invention; and

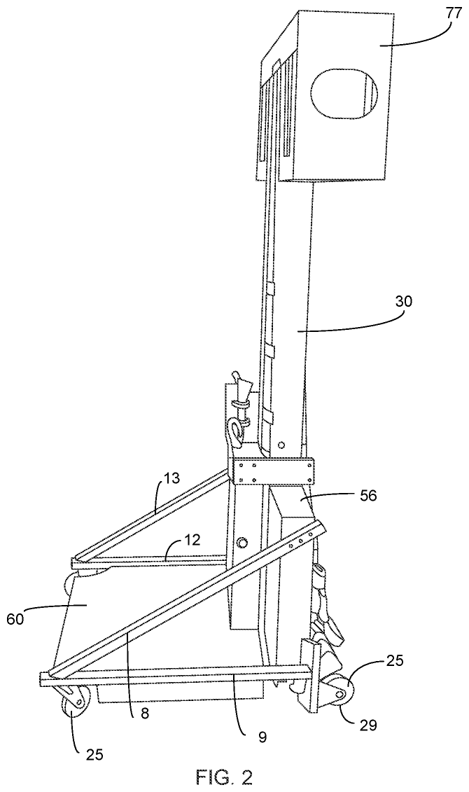

FIG. 3 is a side perspective view of the present invention with the base platform in an elevated position;

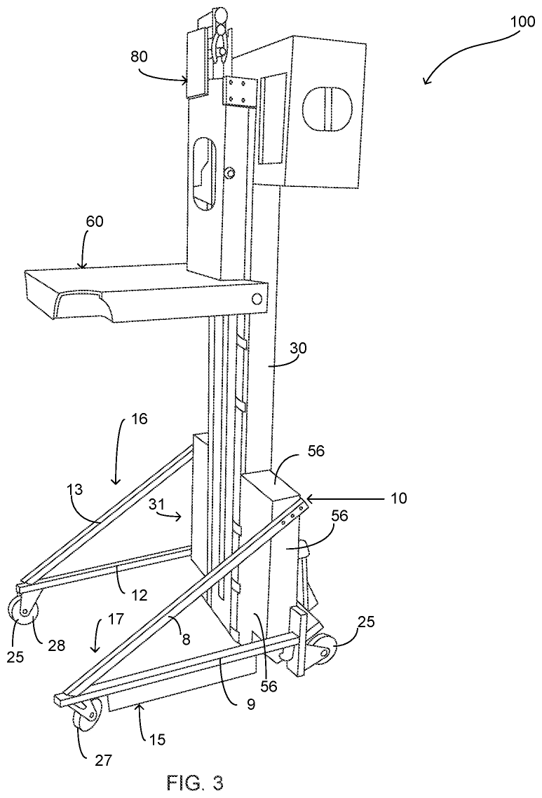

FIG. 4 is a side perspective view of the present invention; and

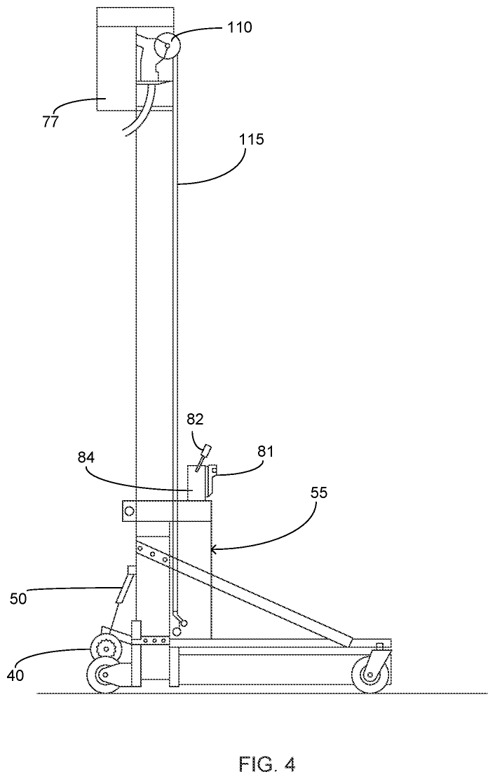

FIG. 5 is a rear view of the present invention.

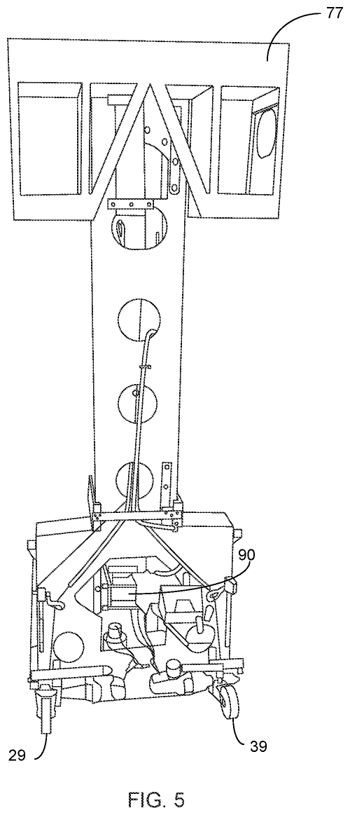

### DETAILED DESCRIPTION

Referring now to the drawings submitted herewith, wherein various elements depicted therein are not necessarily drawn to scale and wherein through the views and figures like elements are referenced with identical reference numerals, there is illustrated a lifting apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted as a part hereof, the lifting apparatus 100 includes a frame 10. The frame 10 is manufactured from a lightweight rigid metal such as but not limited to aluminum. The frame 10 includes a lower support portion 15 wherein the lower support portion 15 is operably coupled to the lower end 31 of the vertical support member 30. The lower support portion 15 includes a first section 16 and a second section 17 wherein the first section 16 and second section 17 are coupled to opposing sides of the lower end 31 of the vertical support member 30. The first section 16 includes first member 13 and second member 12 that are manufactured from a rigid lightweight material such as but not limited to metal. First member 13 is angular in orientation to second member 12 so as to provide stability for the vertical support member 30 and the base platform 60 as it traverses in an upwards-downwards direction on the vertical support member 30. The second section 17 is constructed identically as the first section 16 having first member 8 and second member 9. It should be understood within the scope of the present invention that the first section 16 and second section 17 could be constructed in alternate manners and achieve the objective of providing stability for the lifting apparatus 100.

Secured to the lower support portion 15 are wheels 25. Wheels 25 are configured to allow either independent or controlled movement of the lifting apparatus 100. The rear wheels 27,28 are conventional swivel caster type wheels that rotate three hundred and sixty degrees. The front wheels 29, 39 are fixed in position and are operably coupled to a driving element 40. The driving element 40 is configured to operably engage both front wheels 29, 39 and provide rotational movement thereof in both a clockwise and counterclockwise direction. The driving element 40 in one embodiment is a rotational drum that is engaged with the front wheels 29,39 ensuing a downward force being applied to be the engagement member 50. The driving element 40 is operably coupled to power supply 90 wherein the power supply 90 in a preferred embodiment is a rechargeable eighteen volt battery. It should be understood within the present invention that the necessary power to operate the lifting apparatus 100 and the elements thereof is provided by the power supply 90. It should be understood within the scope of the present invention that the power supply 90 could be alternate sizes in order to achieve the desired objective stated herein.

The lifting apparatus 100 includes lower housing 55 wherein the lower housing 55 is secured to the lower end 31 of the vertical support member 30. The lower housing 55 includes a plurality of walls 56 that are contiguously formed to create an interior volume 57 wherein the interior volume 57 is suitable size to accommodate the power supply 90 and additional elements discussed herein. The base platform 60 is operably coupled to the vertical support member 30 and is configured to traverse therealong in an upwards-downwards direction. The base platform 60 is generally square in shape and is manufactured from a rigid material sufficient to support the weight of a human being thereon. While not particularly illustrated herein, it is contemplated within the scope of the present invention that the base platform 60 could have safety railing secured to the perimeter edge thereof. The base platform 60 includes control station 80 secured thereto utilizing suitable durable techniques. The control station 80 includes user interfaces that are operable coupled to the power supply 90 and elements such as but not limited to the driving element 40 so as to provide operation of the lifting apparatus 100. The control station 80 includes switch 81 that is configured to provide control of the upwards-downwards movement of the base platform 60. It should be understood within the scope of the present invention that the switch 81 could be a momentary directional contact switch wherein movement thereof provides corresponding movement of the base platform 60. Control station 80 further includes a control member 82 that is operably coupled to the driving element 40. Control member 82 is movably secured to the control housing 84 and is operable to provide user input to move the lifting apparatus 100 in a desired motion. It is contemplated within the scope of the present invention that the lifting apparatus 100 could employ two driving elements 40 each coupled independently with the front wheels 29,39 wherein the control member 82 provides operation thereof. In a preferred embodiment the driving elements 40 are reversible so as to provide rotation of the front wheels 29,39 in a desired direction for both forward-backward movement of the lifting apparatus 100 as well as alternate front wheel 29,39 rotation in order to provide turning of the lifting apparatus 100. It should be understood within the scope of the present invention that the control station 80 could be provided in alternate embodiments such as but not limited to a wireless remote control unit.

The vertical support member 30 extends upward from the lower portion 15 and is perpendicular thereto. The vertical support member 30 is manufactured from a rigid material having sufficient structural integrity to support the base platform 60 and a user superposed thereon. The vertical support member 30 in a preferred embodiment is of a length to provide a height of the lifting apparatus 100 that is approximately six feet in height. It should be understood within the scope of the present invention that the vertical support member 30 be provided in a configuration wherein the vertical support member 30 is configured to fold or be telescopic so as to provide easier transport of the lifting apparatus 100. Secured to the top of the vertical support member 30 is container 77. Container 77 is secured to the top of the vertical support member 30 utilizing suitable mechanical techniques. The container 77 has an interior volume that is of suitable size so as to accommodate tools and other implements therein that may be required by a user of the lifting apparatus 100 to execute a task while in an elevated position on the base platform 60. It should be understood within the scope of the present invention that the container 77 could be provided in various sizes and shapes in order to achieve the desired objective. While one container 77 is illustrated and discussed herein, it is contemplated within the scope of the present invention that the lifting apparatus 100 could have more than one container 77.

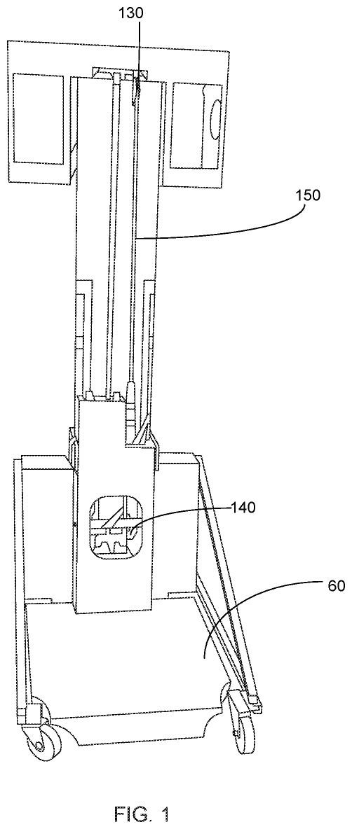

A winch 110 is mounted to the top of the vertical support member 30. The winch 110 is mounted utilizing suitable techniques and is operably coupled to base platform 60 via cable 115. The winch 110 is an electrically powered winch 110 that is operably coupled to power supply 90. Rotational movement of the winch 110 is configured to traverse the base platform 60 in an upwards or downwards direction wherein engagement of switch 81 controls this motion. While a winch 110 and cable 115 are illustrated and discussed herein being provided to move the base platform 60, it is contemplated within the scope of the present invention that the lifting apparatus 100 could employ alternate elements to provide movement of the base platform 60. By way of example but not limitation, the vertical support member 30 could have disposed therein a worm drive wherein the base platform 60 would be operably coupled to the worm drive to provide movement thereof. FIG. 1 shows an alternative embodiment for providing movement of the base platform 60. Electric motor 140 is disposed in lower housing 55 wherein the motor 140 is operably coupled to cable 150, which is coupled to pulley 130. In this configuration the rotational movement of a shaft of wheel on the motor (not particularly illustrated herein) provides movement of the cable 150 which is operably coupled to the base platform 60 proximate the vertical support member 30.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A personal lift platform operable to move an individual to an elevated position wherein the personal lift platform comprises:
a frame, said frame having a lower support portion, said lower support portion having four corners, said lower support portion having a first section and a second section, said first section and said second section being on opposing sides of said frame, said first section and said second section extending outward from said lower support portion and further being parallel, said first section and said second section having a void therebetween;
a vertical support member, said vertical support member being secured to said lower support portion of said frame and extending upward therefrom, said vertical support member having a lower end and an upper end;
a base platform, said base platform being planar in manner and manufactured from a rigid material, said base platform being movably coupled to said vertical support member, said base platform operable to move in an upwards-downwards movement along said vertical support member;
a motor and cable assembly, said motor and cable assembly secured to said vertical support member, said motor and cable assembly operably coupled to said base platform, said motor and cable assembly configured to provide movement of said base platform.

2. The personal lift platform operable to move an individual to an elevated position as recited in claim 1, and further including four wheels, said four wheels being secured to each of said four corners of said lower support portion.

3. The personal lift platform operable to move an individual to an elevated position as recited in claim 2, and further including a control station, said control station located on a control housing wherein the control housing is superposed an upper surface of the base platform, said control station having interface elements configured to provide operation of the personal lift platform.

4. The personal lift platform operable to move an individual to an elevated position as recited in claim 3, and further including at least one drive motor, said at least one drive motor configured to engage two of said four wheels, said at least one drive motor being operably coupled to said control station.

5. The personal lift platform operable to move an individual to an elevated position as recited in claim 4, wherein said first section of said lower support portion includes a first member and a second member, said second member being configured at an angle with respect to said first member so as to provide structural support for the personal lift platform when said base platform is in an elevated position.

6. The personal lift platform operable to move an individual to an elevated position as recited in claim 5, and further including a power supply, said power supply operably coupled to said control station, said at least one drive motor and said motor and cable assembly.

7. The personal lift platform operable to move an individual to an elevated position as recited in claim 6, and further including at least one container, said at least one container being secured to said upper end of said vertical support member, said at least one container having an interior volume for receiving tools therein.

8. The personal lift platform operable to move an individual to an elevated position as recited in claim 7, and further including a lower housing, said lower housing being located proximate said lower end of said vertical support member, said lower housing having an interior volume operable to house said power supply.

9. A portable lifting platform configured to lift a single individual to an elevated position wherein the portable lifting platform comprises:
a frame, said frame having a lower support portion, said lower support portion having four corners, said lower support portion having a first section and a second section, said first section having a first support member and a second support member, said second support member being above said first support member and angular in orientation therewith, said first section and said second section being on opposing sides of said frame, said first section and said second section extending outward from said lower support portion and further being parallel, said first section and said second section having a void therebetween;
a vertical support member, said vertical support member being secured to said lower support portion of said frame and extending upward therefrom, said vertical support member having a lower end and an upper end;
a base platform, said base platform being planar in manner and manufactured from a rigid material, said base platform having a first position and a second position, said base platform being in said void between said first section and said second section in said first position, said base platform being movably coupled to said vertical support member, said base platform operable to move in an upwards-downwards movement along said vertical support member;
a motor and cable assembly, said motor and cable assembly secured to said vertical support member, said motor and cable assembly operably coupled to said base platform, said motor and cable assembly configured to provide movement of said base platform;
four wheels, said four wheels being secured to each of said four corners of said frame, two of said four wheels being operably coupled to a wheel drive motor, said wheel drive motor configured to provide operation of said two of said four wheels.

10. The portable lifting platform configured to lift a single individual to an elevated position as recited in claim 9, wherein in said second position said base platform is proximate said upper end of said vertical support member.

11. The portable lifting platform configured to lift a single individual to an elevated position as recited in claim 10, wherein said second section of said lower support portion includes a first member and a second member, said second member of said second section being configured at an angle with respect to said first member of said second section so as to provide structural support for the personal lift platform when said base platform is in its second position.

12. The portable lifting platform configured to lift a single individual to an elevated position as recited in claim 11, and further including a container, said container being secured to said upper end of said vertical support platform, said container having an interior volume configured to receive tools therein.

13. The portable lifting platform configured to lift a single individual to an elevated position as recited in claim 12, and further including a lower housing, said lower housing being located proximate said lower end of said vertical support member, said lower housing having an interior volume operable to house a power supply.

14. The portable lifting platform configured to lift a single individual to an elevated position as recited in claim 13, and further including a control station, said control station located on a control housing wherein the control housing is superposed an upper surface of the base platform, said control station having a switch and a control member operably coupled to said power supply, said wheel drive motor and said motor and cable assembly.

15. The portable lifting platform configured to lift a single individual to an elevated position as recited in claim 14, wherein in said second position said base platform is approximately six feet above a surface on which the lofting platform is disposed.
